(19) United States
(12) Patent Application Publication
(10) Pub. No.: US 2013/0081482 A1
(43) Pub. Date: Apr. 4, 2013

(54) ENVIRONMENT PROVIDING DEVICE AND ENVIRONMENT EVALUATING METHOD

(71) Applicant: AZBIL Corporation, Tokyo (JP)

(72) Inventor: Shinsuke YAMASAKI, Tokyo (JP)

(73) Assignee: AZBIL CORPORATION, Tokyo (JP)

(21) Appl. No.: 13/644,513

(22) Filed: Oct. 4, 2012

(30) Foreign Application Priority Data
Oct. 4, 2011 (JP) 2011-220085

(51) Int. Cl. G01N 1/22

(52) U.S. Cl. 73/863.22

(57) ABSTRACT

An environment providing device having a test chamber provided, in one face thereof, with a plurality of gas intake vents, where a respective plurality particle detecting devices is provided; and an injecting device for injecting particles into the test chamber.

### CROSS-REFERENCE TO PRIOR APPLICATION

This application claims priority to Japanese Patent Application No. 2011-220085, filed Oct. 4, 2011. This application is incorporated herein by reference in its entirety.

### FIELD OF TECHNOLOGY

The present invention relates to a technology for evaluating an environment, and, in particular, relates to an environment providing device, and an environment evaluating method.

### BACKGROUND

In, for example, clean rooms in semiconductor manufacturing factories, the quantity of particles suspended in the air within the room is monitored using a particle detecting device. In evaluating the particle capturing performance of particle detecting devices, the correspondence between the quantity of particles dispersed in the air within the test environment and the results of detection by the particle detecting device is examined. At this time, it is desirable to be able to control accurately the quantity of particles dispersed in the air in the test environment. (See, for example, Japanese Unexamined Patent Application Publication 2004-159508, Japanese Unexamined Patent Application Publication 2008-22764, and Japanese Unexamined Patent Application Publication 2008-22765.)

### SUMMARY

Given this, the present invention has, as one of the objects thereof, the provision of an environment providing device and an environment evaluating method able to provide an environment wherein the quantity of particles dispersed in the air can be controlled accurately.

A form of the present invention provides an environment providing device having (a) a test chamber in which a particle detecting device is provided, and which is provided with a particle-adhesion-resistant duct; and (b) an injecting device for injecting particles into the test chamber.

A form of the present invention provides an environment evaluating method including (a) connecting a particle detecting device to a test chamber through a particle-adhesion-resistant duct; (b) injecting particles into the test chamber; and (c) detecting particles that are dispersed in the air within the chamber, using the particle detecting device.

The present invention enables the provision of an environment providing device and an environment evaluating method able to provide an environment wherein the quantity of particles dispersed in the air is controlled accurately.

### BRIEF DESCRIPTION OF THE DRAWINGS

FIG. 1 is a top perspective diagram viewing an environment providing device in an example according to the present invention.

FIG. 2 is a side perspective diagram viewing the environment providing device in an example according to the present invention.

FIG. 3 is a cross-sectional diagram of a flow meter according to a further example.

FIG. 4 is a perspective diagram of a flow sensor according to another example.

FIG. 5 is a cross-sectional diagram along the section V-V of the flow sensor illustrated in FIG. 4.

FIG. 6 is a cross-sectional diagram of a flow rate controlling device according to a yet further example.

FIG. 7 is a side view diagram of a particle-adhesion-resistant duct according to an example of the present invention.

FIG. 8 is a side view diagram of a particle-adhesion-resistant duct according to another example.

FIG. 9 is a side view diagram of a particle-adhesion-resistant duct according to a further example.

FIG. 10 is a table showing the effects of an example according to the present invention.

FIG. 11 is a graph showing the effects of another example according to the present invention.

### DETAILED DESCRIPTION

Examples of the present invention are described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

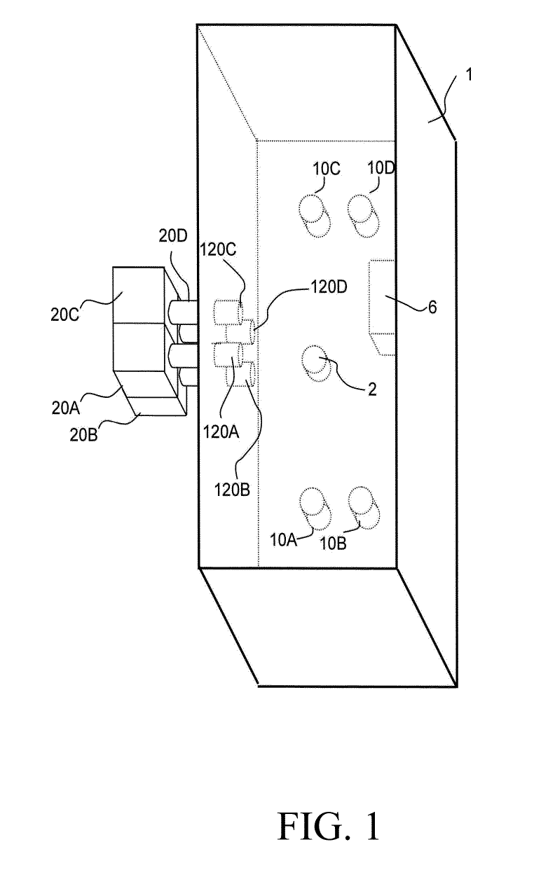

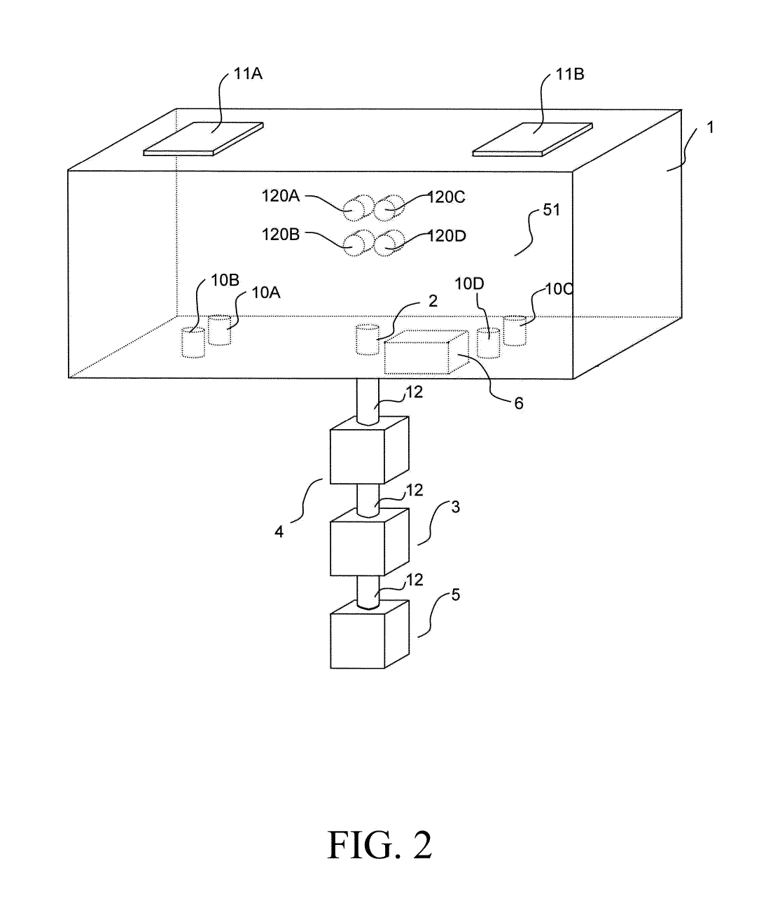

The environment providing device according to the example illustrated in FIG. 1 and FIG. 2 has a test chamber 1 provided, in one face thereof, with a plurality of gas intake vents 120A, 120B, 120C, and 120D, where a respective plurality particle detecting devices 20A, 20B, 20C, and 20D is provided; and an injecting device 2 for injecting particles into the test chamber 1.

The test chamber 1 is a chamber that is provided with, for example, an aluminum frame and transparent panels, made from antistatic polycarbonate, fitted into the frame to serve as side walls. Note that the form of the test chamber 1 may be a duct, or the like. The interior volume of the test chamber 1 is, for example, 3 m³, but there is no limitation thereto. Air supplying devices 11A and 11B, for example, are provided in the test chamber 1. The air supplying devices 11A and 11B supply, into the test chamber 1, clean air through ultrahigh performance air filters such as HEPA filters (High Efficiency Particulate Filters) or ULPA filters (Ultra Low Penetration Air Filters), or the like. A door may be provided in a side wall of the test chamber 1.

The injecting device 2 is, for example, a spraying device such as a jet-type nebulizer. The injecting device 2 stores, internally, a fluid that includes particles at, for example, a prescribed concentration, and receives the supply of an airflow, such as a compressed gas, at a prescribed flow rate. The injecting device 2 is supplied with a gas flow to produce an aerosol through spraying the fluid that contains the particles with the gas flow, to spray, in the form of a mist, the fluid that contains the particles into the test chamber 1. Particles that are included in the fluid are microorganisms such as bacteria, funguses, viruses, allergen substances, or the like. Conversely, the particles that are included in the fluid may be, for example, non-toxic or toxic chemical substances. Conversely, the particles that are included in the fluid may be dust particles. Note that while in the FIG. 1 and FIG. 2, the injecting device 2 is disposed within the test chamber 1, the injecting device 2 may instead be disposed on the outside of the test chamber 1, with the aerosol that is sprayed by the injecting device 2 directed into the test chamber 1 through ducting, or the like.

As illustrated in FIG. 2, the environment providing device according to the example further has a flow meter 3 for measuring a measured value for the flow rate of the gas flow that is provided to the injecting device 2; a flow rate controlling device 4 for controlling, based on the measured value, the flow rate of the gas flow that is provided to the injecting device 2, and a storage tank 5 for storing a compressed gas. The storage tank 5, the flow meter 3, the flow rate controlling device 4, and the injecting device 2 are connected by pipes 12, for example. Moreover, in order to remove particles, and the like, that are included in the compressed gas, an ultrahigh performance filter, such HEPA filter, or the like, is provided between the storage tank 5 and the flow rate meter 3. Note that the storage tank 5 may be replaced with a compressed gas supplying source, such as a compressor or a pump.

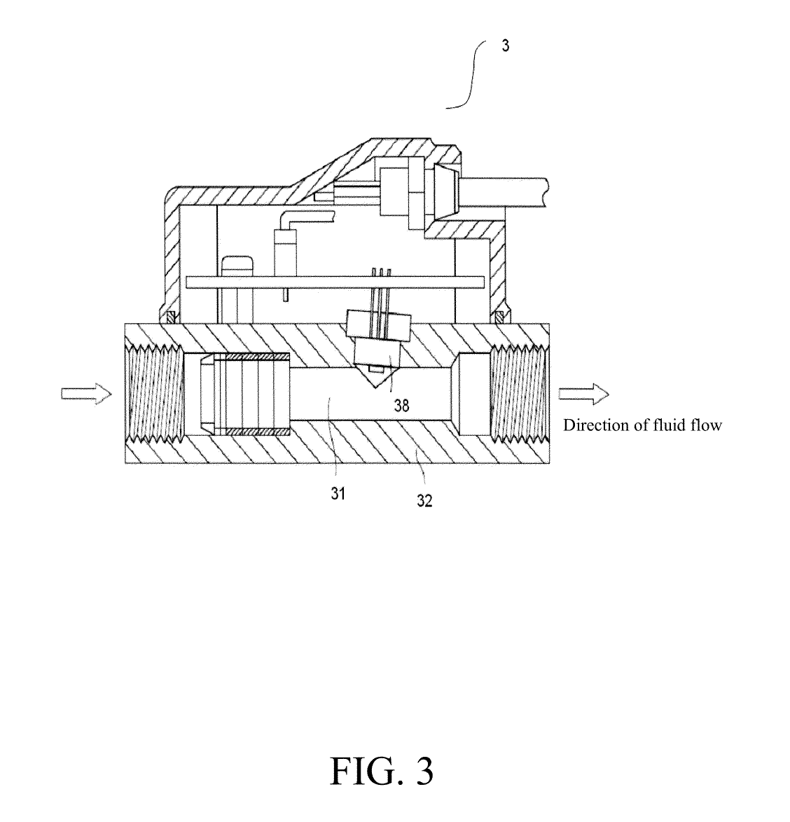

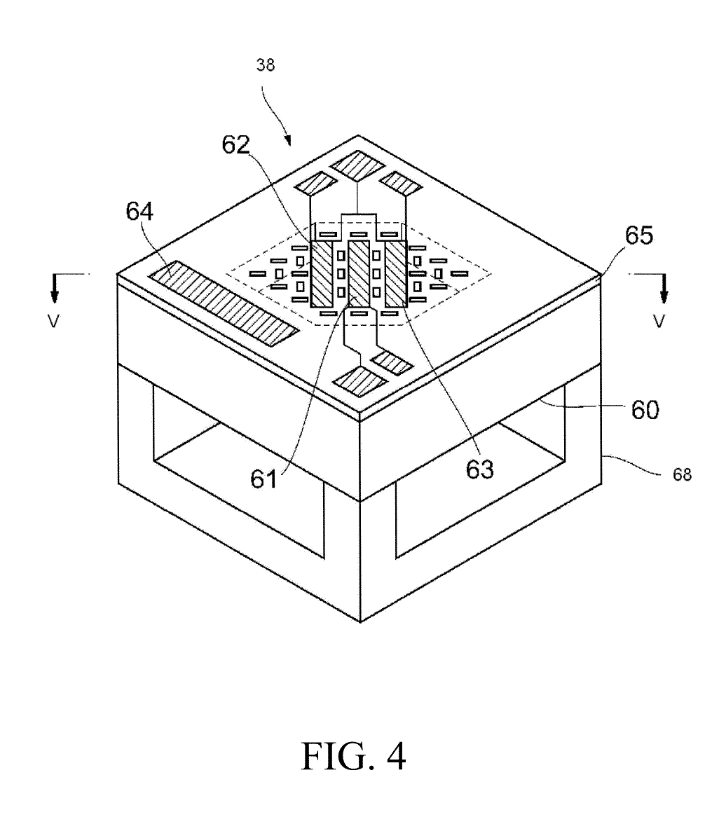

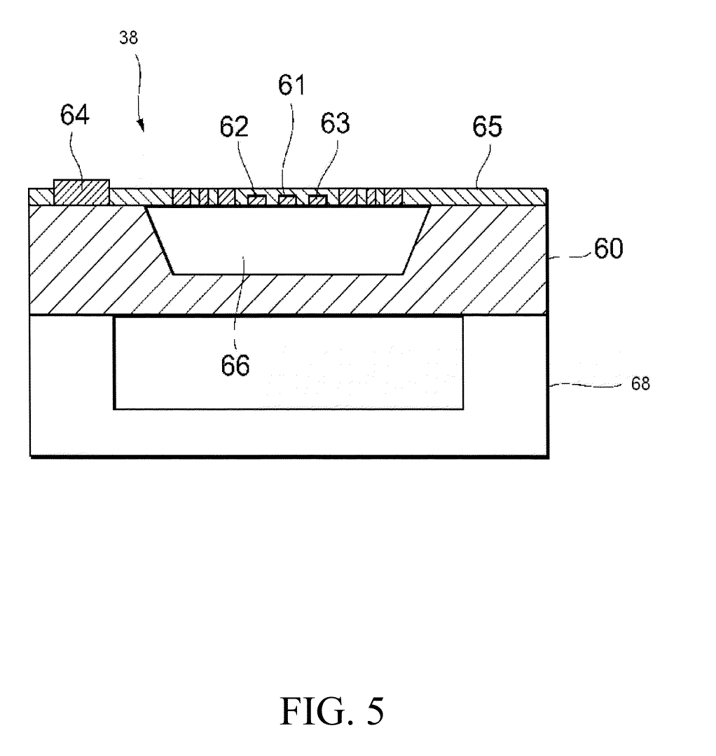

The flow meter 3 may use a mass flow meter, or the like, to measure a measured value for the flow rate of the compressed gas that is supplied from the storage tank 5. As illustrated in FIG. 3, the flow meter 3 is provided with a frame 32 in which is provided a pipe-like flow path 31 that is connected to the pipe 12, and a flow sensor 38 for detecting the flow rate of the compressed gas that flows in the flow path 31. The flow sensor 38 illustrated in FIG. 4 and FIG. 5 is provided with a substrate 60, which is provided with a cavity 66, and an electrically insulating film 65 that is disposed on the substrate 60 so as to cover the cavity 66. The thickness of the substrate 60 is, for example, 0.5 mm. The length and width dimensions of the substrate 60 are, for example, 1.5 mm each. The portion of the insulating layer 65 that covers the cavity 66 forms a thermally insulating diaphragm. Moreover, the flow sensor 68 is provided with a heat generating element 61 that is provided in the diaphragm part of the insulating film 65, a first temperature measuring element 62 and a second temperature measuring element 63 that are provided at the diaphragm part of the insulating film 65 so as to have the heat generating element 61 interposed therebetween, and a temperature maintaining element 64 that is provided on the substrate 60.

The heat producing element 61 is disposed in the center of the portion of the diaphragm of the insulating layer 65 that covers the cavity 66. In the heat generating element 61 is, for example, a resistor, to generate heat through the application of electric power, to heat the compressed gas that contacts the heat generating element 61. The first temperature measuring element 62 and the second temperature measuring element 63 are electronic elements such as passive elements such as, for example, resistors, or the like, to output electric signals in accordance with the temperature of the compressed gas. The first temperature measuring element 62 and the second temperature measuring element 63 are electronic elements such as passive elements such as, for example, resistors, or the like, to output electric signals in accordance with the temperature of the compressed gas.

When the gas within the flow path 31 that is illustrated in FIG. 3 is stationary, the heat that is applied to the compressed gas from the heat generating element 61 that is illustrated in FIG. 4 and FIG. 5 can propagate symmetrically in the upstream direction and the downstream direction. Consequently, the temperatures in the first temperature measuring element 62 and the second temperature measuring element 63 can be equal, and the electrical resistances in the first temperature measuring element 62 and the second temperature measuring element 63, which are made out of platinum, or the like, can be equal. In contrast, when there is a flow of the compressed gas from upstream to downstream in the flow path 31 illustrated in FIG. 3, the heat that is applied to the compressed gas from the temperature-measuring element 61 that is illustrated in FIG. 4 and FIG. 5 can be carried in the downstream direction by the compressed gas. Consequently, the temperature of the second temperature measuring element 63 on the downstream side can be higher than the temperature of the first temperature measuring element 62 on the upstream side. Because of this, a difference can be produced between the electrical resistance of the first temperature measuring element 62 and the electrical resistance of the second temperature measuring element 63. The difference between the electrical resistance of the second temperature measuring element 63 and the electrical resistance of the first temperature measuring element 62 can be correlated with the speed of the compressed gas within the flow path 61 that is illustrated in FIG. 2. Because of this, the flow rate of the compressed gas that flows in the flow path 31 can be calculated from the difference between the electrical resistance of the second temperature measuring element 63 and the electrical resistance of the first temperature measuring element 62.

The temperature maintaining element 64, illustrated in FIG. 4 and FIG. 5, is, for example, a resistor, which is provided with electric power to generate heat to maintain the substrate 60 at a constant temperature. Silicon (Si), or the like, may be used as the material for the substrate 60. Silicon dioxide (SiO2), or the like, may be used as the material for the insulating layer 65. The cavity 66 may be formed through anisotropic etching, or the like. Furthermore, platinum (Pt) or the like may be used as the material for the first temperature measuring element 62, the second temperature measuring element 63, and the temperature maintaining element 64, and they may be formed through a lithographic method, or the like.

The flow sensor 38 is secured in the flow path 31, illustrated in FIG. 3, by a thermally insulating material 68 made from glass, or the like, that is disposed on the bottom face of the flow sensor 38. Securing the flow sensor 38 in the flow path 31 through the thermally insulating material 68 reduces the susceptibility of the temperature of the flow sensor 38 to the effects of temperature fluctuations of the inner wall of the flow path 31.

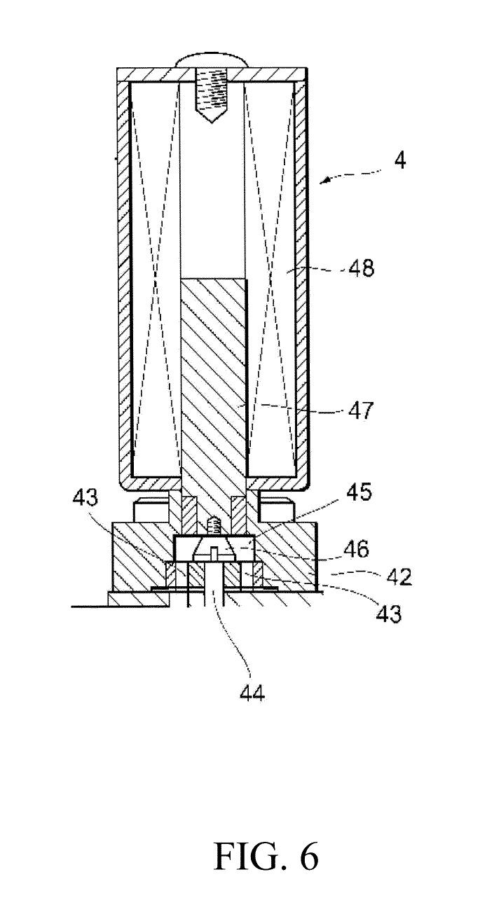

The flow rate controlling device 4 illustrated in FIG. 2 controls, to a prescribed value, the flow rate of the compressed gas that flows in the pipe 12, based on the measured value for the flow rate that is measured by the flow meter 3. As illustrated in FIG. 6, the flow rate controlling device 4 is provided with a valve seat that is provided with a flow path 43, a flow path 44, and a valve chamber 45 provided between the flow path 43 and the flow path 44. Moreover, the flow rate controlling device 4 is provided with a plunger 47 of a magnetic substance, a solenoid coil 48 to which an electric current is applied to drive the plunger 47 up and down, and a valve body 46, housed within the valve chamber 45, that is connected to the plunger 47 to open and close the flow path 44.

If, for example, the measured value for the flow rate of the compressed gas, measured by the flow meter 3, were greater than the prescribed value, then the flow rate controlling device 4 would apply an electric current to the solenoid coil 48, to reduce the gap between the valve body 46 and the valve seat 42, to reduce the flow rate of the compressed gas. Moreover, if the measured value for the flow rate of the compressed gas, measured by the flow meter 3, were less than the prescribed value, the flow rate controlling device 4 applies an electric currents to the solenoid 48 to increase the gap between the valve body 46 and the valve seat 42, to increase the flow rate of the compressed gas. Doing so controls, to the vicinity of the prescribed value, the flow rate of the compressed gas that flows through the pipe 12 to be supplied to the injecting device 2. Note that while in FIG. 2 the flow rate controlling device 4 is disposed downstream from the flow meter 3, the flow rate controlling device 4 may instead be disposed upstream from the flow meter 3.

As illustrated in FIG. 1 and FIG. 2, agitating fans 10A, 10B, 10C, and 10D are disposed as agitating devices within the test chamber 1. The agitating fans 10A through 10D agitate the air within the test chamber 1, to prevent natural settling, by their own weight, of the particles that are dispersed into the air within the test chamber 1.

Moreover, an air cleaner 6, as a cleaning device, is disposed within the test chamber 1. The air cleaner 6 removes particles that are included in the gas, such as air, or the like, within the test chamber 1, to clean the gas. For example, the air cleaner 6 is operated prior to spraying of the fluid, which includes the particles from the injecting device 2 into the test chamber 1, to remove, from the test chamber 1, any particles other than the particles that are sprayed from the injecting device 2. Note that while in FIG. 1 and FIG. 2 the air cleaner 6 is disposed on the bottom surface within the test chamber 1, the air cleaner 6 may instead be disposed on a wall or the ceiling of the test chamber 1.

Each of the particle counter devices 20A through 20D draw in air from within the test chamber 1 to capture particles, to measure a quantity such as the number, density, or concentration of particles dispersed in the air within the test chamber 1.

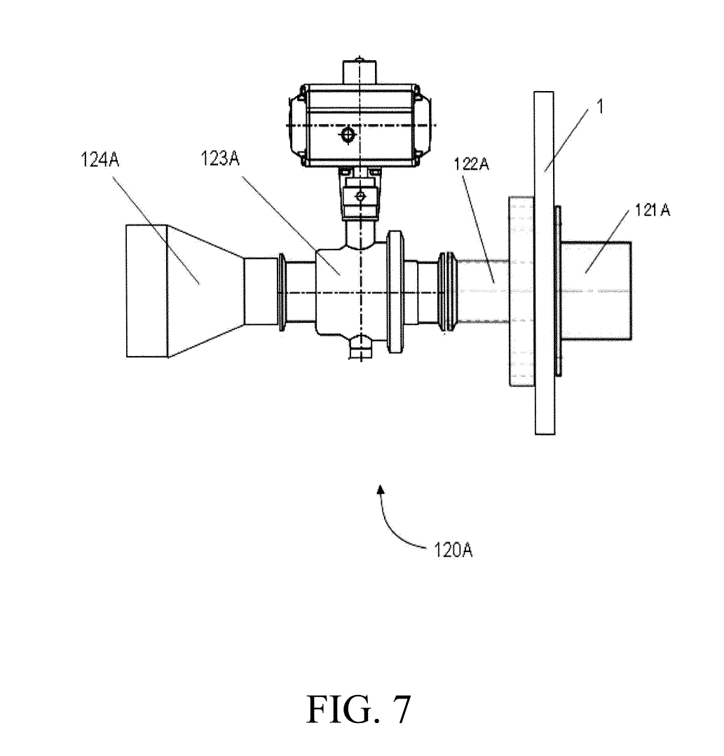

A particle-adhesion-resistant duct 120A, as illustrated in FIG. 7, for example, comprises a flanged duct 121A that is provided on the inside of a side wall of the test chamber 1; a flanged connector 122A, that communicates with the duct 121A, disposed on the outside of the side wall of the test chamber 1; a ball valve 123A connected to the connector 122A; and a connector 124A that is connected to the ball valve 123A and that can be connected to the particle detecting device 20A. At least a portion of the structural elements of the particle-adhesion-resistant duct 120A is a sanitary duct made from stainless steel (SUS) that has had a surface polishing treatment.

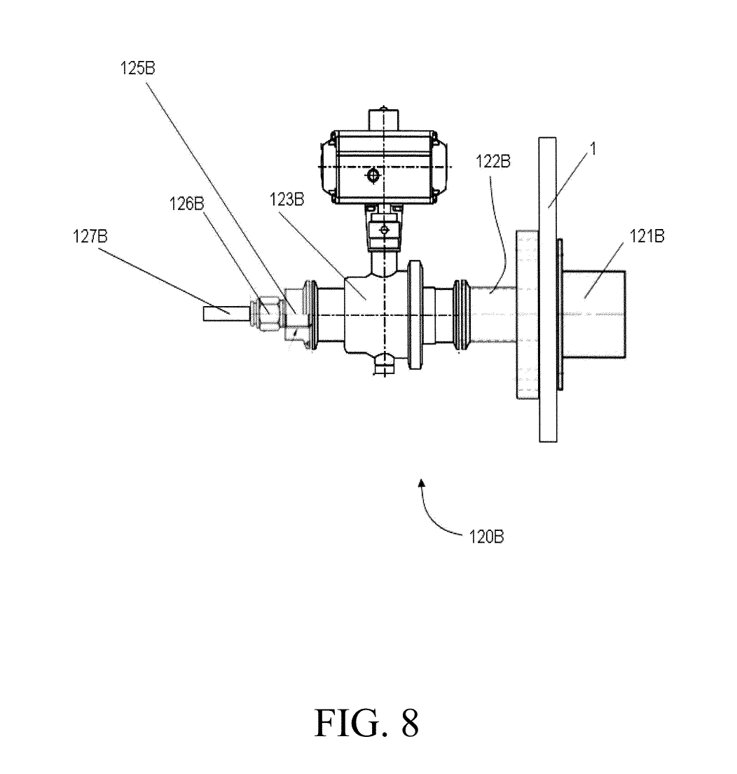

As illustrated in FIG. 8, for example, the particle-adhesion-resistant duct 120B, illustrated in FIG. 1 and FIG. 2, includes a flanged duct 121B that is provided on the inside of a side wall of the test chamber 1; a flanged connector 122B, that communicates with the duct 122B, disposed on the outside of the side wall of the test chamber 1; a ball valve 123B connected to the connector 122B; a ferrule connector 125B, connected to the ball valve 123B; a threaded connector 126B, connected to the ferrule connector 125B; and a connector 127B that is connected to the threaded connector 126B and that can be connected to the particle detecting device 20B. At least a portion of the structural elements of the particle-adhesion-resistant duct 120B is a sanitary duct made from stainless steel (SUS) that has had a surface polishing treatment.

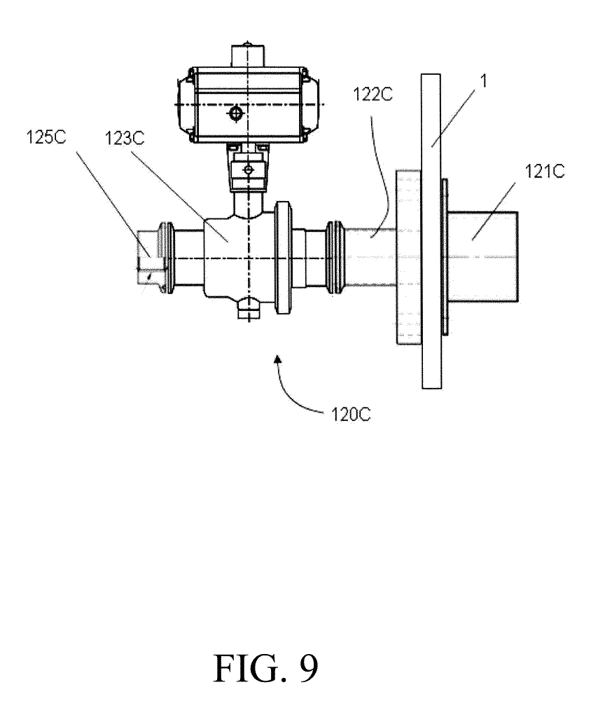

As illustrated in FIG. 9, for example, the particle-adhesion-resistant duct 120C that is illustrated in FIG. 1 and FIG. 2 has a flanged duct 121C that is provided on the inside of a side wall of the test chamber 1; a flanged connector 122C, that communicates with the duct 121C, disposed on the outside of the side wall of the test chamber 1; a ball valve 123C connected to the connector 122C; and a ferrule connector 125C that is connected to the ball valve 123C and that can be connected to the particle detecting device 20A. At least a portion of the structural elements of the particle-adhesion-resistant duct 120C is a sanitary duct made from stainless steel (SUS) that has had a surface polishing treatment.

The details of the particle-adhesion-resistant duct 120D that is illustrated in FIG. 1 and FIG. 2 are, for example, the same as any of the particle-adhesion-resistant duct 120A through 120 C.

Here the inventors discovered that when particles adhere to the ducts for connecting the test chamber 1 and the respective particle detecting devices 20A through 20D, it is difficult to measure accurately the environment within the test chamber 1 due to the background noise when measuring the particles that are dispersed in the air within the test chamber 1 due to the re-dispersion of the particles that were adhered. In this relation, in the environment providing device according to the form of embodiment, the test chamber 1 and the particle detecting devices 20A and 20D are each connected by the particle-adhesion-resistant ducts 120A through 120D, thus suppressing the adhesion of particles to the particle-adhesion-resistant ducts 120A through 120D. Because of this, this enables the accurate measurement of the environment within the test chamber 1 through reducing the background noise due to the re-dispersion of the particles that are adhered to the ducts. Moreover, the particle-adhesion-resistant ducts 120A through 120D, which are sanitary ducts, are cleaned and sterilized easily, thus enabling removal even if a particle were to become adhered. Because of this, the environment providing device according to the present example enables a reduction, through cleaning, even if background noise were to occur.

A stainless steel (SUS304) plate with a #400 polish finish, a steel (SS400) plate, a polycarbonate plate with an anti-static treatment, and a polyethylene terephthalate plate were prepared. Following this, the four plates that were prepared were placed within the test chamber at equal distances from a spraying device. Moreover, a HEPA unit was used to clean the air within the test chamber. Thereafter, a fluid that includes spores of bacillus subtilis was sprayed for one minute from the spraying device, and then paused for 4 minutes, repeated for 30 minutes. During that time, the air within the test chamber was agitated by the agitating fans, to cause the bacillus subtilis within the test chamber to remain airborne. After 30 minutes elapsed, the HEPA unit was used to clean the air within the test chamber, and the four plates were recovered.

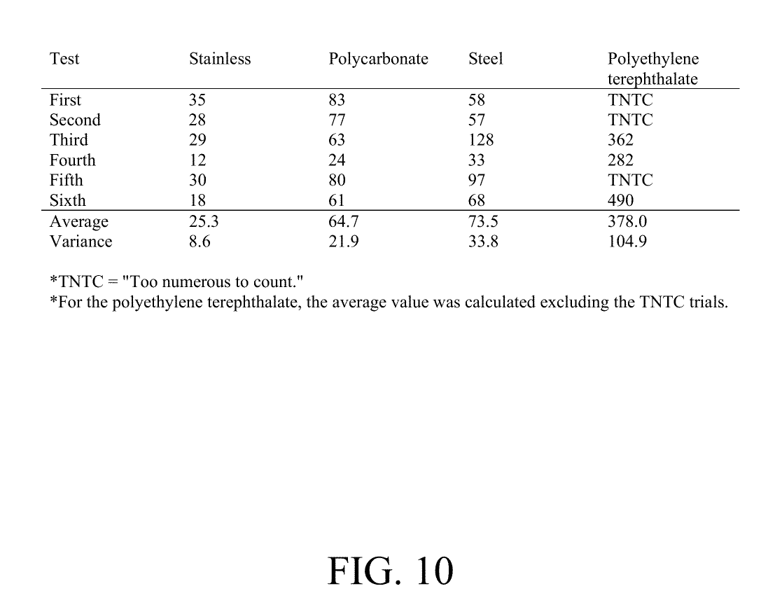

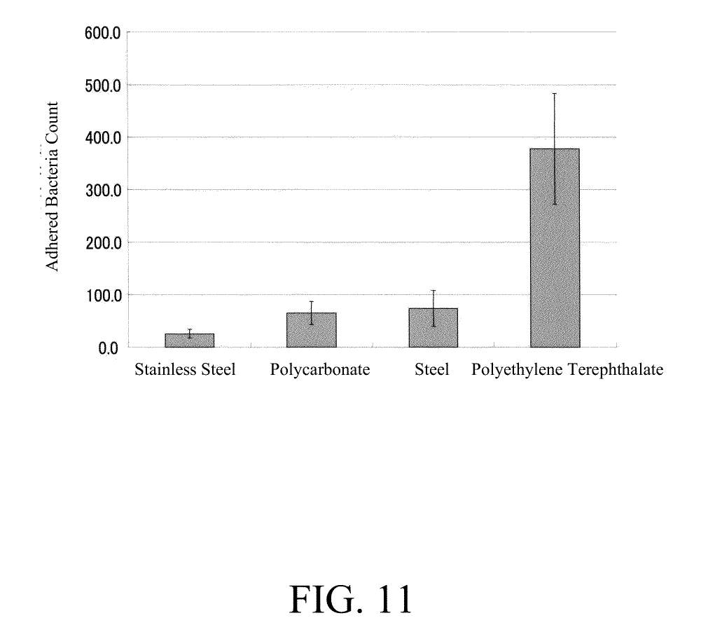

An Eiken Chemical wipe test kit was used to wipe the adhered bacteria from a region of 100 cm² on each of the four recovered plates, and bacteria were collected using a membrane filter, after which the membrane filter was placed in a culture medium to cultivate bacteria. After cultivation, the numbers of bacteria were counted. The result, as shown in FIG. 10 in FIG. 11, was an understanding that the number of adhered bacteria was lowest for the stainless steel plate with the polish finish. Consequently, this suggested that it is possible to prevent the adhesion of bacteria to the duct of the environment providing device through the use of stainless steel to which a polishing process has been performed, as the material for the duct in the environment providing device.

While there are descriptions of examples as set forth above, the descriptions and drawings that form a portion of the disclosure are not to be understood to limit the present invention. A variety of alternate forms of embodiment and operating technologies should be obvious to those skilled in the art. For example, while an example was given wherein the particle detecting devices 20A, 20B, 20C, and 20D, illustrated in FIG. 1, were disposed on the side surface of the test chamber 1, the particle detecting devices 20A, 20B, 20C, and 20D may be placed instead on a bottom surface of the test chamber 1. Furthermore, while, in the form of embodiment, an example was given wherein a mass flow sensor was used as the flow meter 3, other types of flow meters may be used instead. In this way, the present invention should be understood to include a variety of examples, and the like, not set forth herein.

We claim:

1. An environment providing device comprising:
a test chamber equipped with a particle-adhesion-resistant duct, provided with a particle detecting device; and
an injecting device injecting particles into the test chamber;

2. The environment providing device as set forth in claim 1, wherein:
the particle-adhesion-resistant duct is made from stainless steel.

3. The environment providing device as set forth in claim 1, wherein:
the surface of the particle-adhesion-resistant duct has a polish finish.

4. The environment providing device as set forth in claim 1, wherein:
the particle-adhesion-resistant duct is a sanitary duct.

5. The environment providing device as set forth in claim 1, further comprising:
an agitating device agitating the gas within the test chamber.

6. The environment providing device as set forth in claim 1, further comprising:
a cleaning device cleaning the air within the test chamber.

7. An environment evaluating method, comprising the steps of:
connecting a particle detecting device through a particle-adhesion-resistant duct;
injecting particles into the test chamber; and
detecting, using the particle detecting device, particles dispersed in the air in the test chamber.

8. The environment evaluating method as set forth in claim 7, wherein:
the particle-adhesion-resistant duct is made from stainless steel.

9. The environment evaluating method as set forth in claim 7, wherein:
the surface of the particle-adhesion-resistant duct has a polish finish.

10. The environment evaluating method as set forth in claim 7, wherein:
the particle-adhesion-resistant duct is a sanitary duct.

11. The environment evaluating method as set forth in claim 7, further comprising the step of:
agitating the gas within the test chamber.

12. The environment evaluating method as set forth in claim 7, further comprising the step of:
cleaning the air within the test chamber prior to injecting the particles into the test chamber.

13. The environment providing device as set forth in claim 2, wherein:
the surface of the particle-adhesion-resistant duct has a polish finish.

14. The environment providing device as set forth in claim 2, wherein:
the particle-adhesion-resistant duct is a sanitary duct.

15. The environment providing device as set forth in claim 2, further comprising:
an agitating device agitating the gas within the test chamber.

16. The environment providing device as set forth in claim 2, further comprising:
a cleaning device cleaning the air within the test chamber.

17. The environment evaluating method as set forth in claim 8, wherein:
the surface of the particle-adhesion-resistant duct has a polish finish.

18. The environment evaluating method as set forth in claim 8, wherein:
the particle-adhesion-resistant duct is a sanitary duct.

19. The environment evaluating method as set forth in claim 8, further comprising the step of:
agitating the gas within the test chamber.

20. The environment evaluating method as set forth in claim 8, further comprising the step of:
cleaning the air within the test chamber prior to injecting the particles into the test chamber.
